(19) United States
(12) Patent Application Publication
(10) Pub. No.: US 2016/0280057 A1
(43) Pub. Date: Sep. 29, 2016

(54) POWER TRANSMISSION STRUCTURE OF HYBRID VEHICLE WITH ONE MOTOR GENERATOR AND THREE CLUTCHES

(71) Applicants: Myungkoo KANG, Busan (KR); Hyojeong JEON, Busan (KR); Seungmo KANG, Busan (KR); Suejeong KANG, Busan (KR)

(72) Inventors: Myungkoo KANG, Busan (KR); Hyojeong JEON, Busan (KR); Seungmo KANG, Busan (KR); Suejeong KANG, Busan (KR)

(21) Appl. No.: 14/964,897

(22) Filed: Dec. 10, 2015

(30) Foreign Application Priority Data
Mar. 24, 2015 (KR) 10-2015-0040940

(51) Int. Cl. B60K 6/50; B60K 6/442; B60K 6/36; F16H 3/00; B60K 6/387

(52) U.S. Cl. CPC B60K 6/50; F16H 3/006; B60K 6/387; B60K 6/36; B60K 6/442; Y10S 903/915; Y10S 903/914; B60Y 2200/92; B60Y 2400/428; B60Y 2300/182

(57) ABSTRACT

A power transmission structure of a hybrid vehicle includes a motor generator, a first clutch, a second clutch, a third clutch, an engine, a motor, and an output shaft transferring power generated by the engine and power generated by the motor to a transmission. The motor is disposed parallel to the engine, the output shaft extends through a central portion of the motor and is connected to the transmission. The first clutch and the second clutch are disposed as a double clutch on the output shaft between the engine and the motor. The third clutch is disposed between the motor and the transmission to enable and disable power to be transferred via the output shaft.

### BACKGROUND OF THE INVENTION

1. Field of the Invention

The present invention generally relates to a power transmission structure in a hybrid vehicle. More particularly, the present invention relates to a power transmission structure of a hybrid vehicle, in which three clutches regulating output power from each of an engine, a driving motor, and a transmission are provided independently of each other, whereby the driving motor can be prevented from acting as a load in the process of transferring power generated by the engine to the transmission directly, and furthermore, a simplified configuration can improve fuel efficiency and improve the efficiency of regenerative electric power generation as well as the efficiency of electric power generation by the engine.

2. Description of the Related Art

A hybrid vehicle is a vehicle that uses two or more distinct power sources to propel itself. For, example, the hybrid vehicle uses an internal combustion engine and an electric motor. FIGS. 10 to 13 schematically illustrate typical power transmission structures of hybrid vehicles. Specifically, FIG. 10 illustrates the power transmission structure of a Sonata hybrid vehicle from Hyundai, FIG. 11 illustrates the power transmission structure of a hybrid vehicle from Nissan, FIG. 12 illustrates the power transmission structure of a Prius hybrid vehicle from Toyota, and FIG. 13 illustrates the power transmission structure of a Volt hybrid vehicle from Chevrolet. In FIGS. 10 to 13, reference symbols E, M, and TM designate an engine, a motor generator, and a transmission, reference symbol SG designates a starter generator, and reference symbol C designates a clutch.

Referring to these power transmission structures, each of the Prius hybrid vehicle from Toyota and the Volt hybrid vehicle from Chevrolet is characterized by two motor generators, and the Sonata hybrid vehicle from Hyundai is characterized by one motor generator and one starter generator. Thus, in order to drive these hybrid vehicles, a high-voltage battery needs two electrical connector circuit units to be connected to the two motor generators or the motor generator and the starter generator. In addition, two power control units (PCUs) controlling these electrical connector units must be provided.

However, in this case, two electrical connector units and two control units must be separately disposed, thereby increasing fabrication costs, which is problematic. Moreover, the electrical connector units and the control units must be disposed side by side within an engine room. This causes the design of the engine room to be complicated. In addition, electrical interferences may occur between the electrical connector units, between the control units, and between the electrical connector units and the control units, thereby frequently causing malfunctions.

The driving modes of a hybrid vehicle are generally divided into an engine mode in which the vehicle is propelled using power generated only by the engine, an electric vehicle mode in which the vehicle is propelled using power generated by the motor consuming the electricity of the battery, a parallel mode in which the vehicle is propelled using power generated by the engine and power generated by the motor, a combined mode in which the engine not only propels the vehicle but also generates electricity by rotating the motor, a series mode in which the engine only generates electricity by rotating a first driving motor or a generator and the vehicle is propelled exclusively by a second driving motor, an engine charging mode in which electricity is charged by rotating the driving motor or the generator during inertial propulsion or idling, and an regenerative braking mode in which the battery is charged using the driving motor during deceleration.

Among these driving modes, the series mode has the worst fuel efficiency in high-speed driving with high rpm. Thus, the operation in series mode must be restricted as much as possible during high-speed driving with high rpm since this mode lacks the fuel efficiency to enable a vehicle to be called “hybrid.” In addition, it is required to improve the efficiency of electric power generation by the engine and the efficiency of regenerative electric power generation in order to improve the fuel efficiency of a hybrid vehicle in the series mode. When the efficiency of electric power generation is improved, an electrical mode can be used during low-speed cruising in a downtown area or high-speed cruising with higher gear engaged and low rpm in order to improve fuel efficiency.

However, in hybrid vehicles from Nissan, the shaft of the motor is driven to rotate in a position in which the motor is not separated from the engine in the engine mode. In this case, rotatory power generated by the engine may be reduced due to the driven rotation of the motor shaft (parasitic energy consumption of the motor generator). Then, a motor having a large capacity cannot be mounted. Thus, hybrid vehicles from Nissan have limited ability to improve the efficiency of electric power generation by the engine and the efficiency of regenerative electric power generation since only a small motor in comparison to the displacement of the engine can be mounted.

Considering the rotation characteristic of a driving motor, a maximum level of torque can be output at the initial stage of rotation. It is necessary to actively use this rotation characteristic to improve the fuel efficiency of vehicles. In addition, only a low rpm is required for low-speed driving in a downtown area or high-speed cruising with higher gear engaged, and thus active use of the driving motor is necessary. Thus, an effect of improving the fuel efficiency of vehicles may be expected when an approach able to improve the efficiency of electric power generation by the engine and the efficiency of regenerative electric power generation is made.

Independently of the power transmission structures of commercial vehicles, approaches of disposing a double clutch unit between the motor and the transmission have been proposed. Such approaches were disclosed by Korean Patent No. 0999606 and Korean Patent No. 1490917, as illustrated in FIGS. 14 and 15, respectively. These approaches differ from the above-described Prius hybrid vehicle from Toyota and the above-described Volt hybrid vehicle from Chevrolet in that a single motor is used as a power source. And these approaches differ from the above-described hybrid vehicle from Hyundai Sonata and the above-described hybrid vehicle from Nissan in that a double clutch is disposed between the transmission and the motor.

That is, each of these approaches is advantageous in that power generated by the engine and power generated by the motor can be selectively transferred to the transmission using the double clutch. However, the former approach does not have the clutch between the transmission and the motor even in the case in which the transmission is assumed to be the CVT that cannot have a neutral position. In addition, in the former approach, the transmission is disconnected from a power transmission route by the clutch. In this configuration, it is impossible to generate power by rotating the driving motor using the engine. In this case, a starter generator is required, in which case each of the driving motor and the starter generator must be provided with a high-voltage connector unit and a control unit. Therefore, this approach has the same problems as the above-described Sonata hybrid vehicle from Hyundai.

The latter approach has the same problems since one clutch of the double clutch (substantially a dual clutch regardless of the name “double clutch”) remains connected to the transmission. In addition, as apparent from FIG. 14, part of rotatory power generated by the engine to be transferred to the transmission 12 is inevitably reduced by the driven rotation of the motor 2, whereby a motor having a large capacity cannot be mounted. Thus, this approach also has the same problems as the above-described hybrid vehicle from Nissan.

The information disclosed in the Background of the Invention section is only for the enhancement of understanding of the background of the invention, and should not be taken as an acknowledgment or as any form of suggestion that this information forms a prior art that would already be known to a person skilled in the art.

### RELATED ART DOCUMENT

Patent Document 1: Korean Patent No. 0999606

Patent Document 2: Korean Patent No. 1490917

### SUMMARY OF THE INVENTION

Accordingly, the present invention has been made keeping in mind the above problems occurring in the related art, and the present invention is intended to propose a power transmission structure of a hybrid vehicle having a simple configuration, able to significantly reduce fabrication costs and maintenance costs, and having superior fuel efficiency and performance as well as a superior operating mechanism.

In order to achieve the above object, according to one aspect of the present invention, a power transmission structure of a hybrid vehicle includes: a motor generator; a first clutch, a second clutch, and a third clutch; an engine; a motor; and an output shaft transferring power generated by the engine and power generated by the motor to a transmission. The motor is disposed parallel to the engine, the output shaft extends through a central portion of the motor and is connected to the transmission, the first clutch and the second clutch are disposed as a double clutch on the output shaft between the engine and the motor, and the third clutch is disposed between the motor and the transmission to enable and disable power to be transferred via the output shaft.

According to another aspect of the present invention, a power transmission structure of a hybrid vehicle includes: a motor generator; a first clutch, a second clutch, and a third clutch; an engine; a motor; and an output shaft transferring power generated by the engine and power generated by the motor to a transmission. The motor is disposed parallel to the engine, the output shaft extends through a central portion of the motor and is connected to the transmission, the second clutch and the first clutch are disposed as a double clutch on the output shaft between the motor and the transmission, and the third clutch is disposed between the motor and the engine to enable and disable power to be transferred via the output shaft.

According to further another aspect of the present invention, a power transmission structure of a hybrid vehicle includes: a motor generator; a first clutch, a second clutch, and a third clutch; an engine; a motor; and an output shaft transferring power generated by the engine and power generated by the motor to a transmission. The motor is disposed parallel to the engine, the output shaft extends through a central portion of the motor and is connected to the transmission, the second clutch and the first clutch are disposed as a double clutch on the output shaft between the motor and the transmission, and the third clutch is disposed between the dual clutch and the transmission to enable and disable power to be transferred via the output shaft.

According to still another aspect of the present invention, a power transmission structure of a hybrid vehicle includes: a motor generator; a first clutch, a second clutch, and a third clutch; an engine; a motor; and an output shaft transferring power generated by the engine and power generated by the motor to a transmission. The motor is disposed parallel to the engine, the output shaft extends through a central portion of the motor and is connected to the transmission, the first clutch and the second clutch are disposed as a dual clutch or a double clutch on the output shaft between the engine and the motor, and the third clutch is disposed between the motor and the transmission to enable and disable power generated by the motor to be transferred via the output shaft.

According to another aspect of the present invention, a power transmission structure of a hybrid vehicle includes: a motor generator; a first clutch, a second clutch, and a third clutch; an engine; a motor; and an output shaft transferring power generated by the engine and power generated by the motor to a transmission. The motor is disposed parallel to the engine, the output shaft extends through a central portion of the motor and is connected to the transmission, the first clutch and the second clutch are disposed as a dual clutch on the output shaft between the engine and the motor, and the third clutch is disposed between the engine and the dual clutch.

According to further another aspect of the present invention, a power transmission structure of a hybrid vehicle includes: a motor generator; a first clutch, a second clutch, and a third clutch; an engine; a motor; and an output shaft transferring power generated by the engine and power generated by the motor to a transmission. The motor is disposed parallel to the engine, the output shaft extends through a central portion of the motor and is connected to the transmission, the third clutch is disposed between the engine and the motor, and the second clutch and the first clutch are disposed as a dual clutch or a double clutch on the output shaft between the motor and the transmission.

According to still another aspect of the present invention, a power transmission structure of a hybrid vehicle includes: a motor generator; a first clutch, a second clutch, and a third clutch; an engine; a motor; and an output shaft transferring power generated by the engine and power generated by the motor to a transmission. The motor is disposed parallel to the engine, the output shaft extends through a central portion of the motor and is connected to the transmission, the first clutch, the second clutch, and the third clutch are disposed as a triple clutch on the output shaft between the engine and the motor.

According to yet another aspect of the present invention, a power transmission structure of a hybrid vehicle includes: a motor generator; a first clutch, a second clutch, and a third clutch; an engine; a motor; and an output shaft transferring power generated by the engine and power generated by the motor to a transmission. The motor is disposed parallel to the engine, the output shaft extends through a central portion of the motor and is connected to the transmission, and the third clutch, the second clutch, and the first clutch are disposed as a triple clutch on the output shaft between the motor and the transmission.

According to the present invention, output power can be prevented from being reduced by the driven rotation of the motor, in which the engine and the motor are connected to the output shaft, whereby the motor having a large capacity in comparison to the displacement of the engine can be mounted. It is therefore possible to improve the fuel efficiency of the engine and significantly increase the amount of power generated by the motor.

In addition, according to the present invention, mechanical power and electricity can be generated by a single motor, which also functions as a starter. This configuration can significantly reduce electronic control units, thereby causing fabrication to be simple. Since a single high-voltage electrical circuit and a single high-voltage power control unit (PCU) are used, it is possible to minimize the occurrence of interferences due to the complicated electrical circuit configuration of the related art. It is therefore possible to reduce the fabrication costs of a vehicle and facilitate the maintenance and repair of the control units.

Furthermore, according to the present invention, the three clutches operating independently of each other are provided. This configuration allows the motor to propel the vehicle and enables regenerative electric power generation by the motor and electric power generation by the engine. It is therefore possible to improve fuel efficiency and maximize the efficiency of electric power generation and regeneration.

In addition, according to the present invention, a motor having a suitable capacity in comparison to the displacement of the engine can be selected. Furthermore, power input from the engine can be suitably adjusted to the optimum number of revolutions of the motor. It is therefore possible to propel the vehicle with optimum fuel efficiency and optimize the efficiency of power generation by the motor.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a schematic configuration view illustrating an exemplary power transmission structure of a hybrid vehicle according to the present invention;

FIG. 2 is a schematic configuration view illustrating another exemplary power transmission structure of a hybrid vehicle according to the present invention;

FIG. 3 is a schematic configuration view illustrating further another exemplary power transmission structure of a hybrid vehicle according to the present invention;

FIG. 4 is a schematic configuration view illustrating still another exemplary power transmission structure of a hybrid vehicle according to the present invention;

FIG. 5 is a schematic configuration view illustrating another exemplary power transmission structure of a hybrid vehicle according to the present invention;

FIG. 6 is a schematic configuration view illustrating further another exemplary power transmission structure of a hybrid vehicle according to the present invention;

FIG. 7 is a schematic configuration view illustrating still another exemplary power transmission structure of a hybrid vehicle according to the present invention;

FIG. 8 is a schematic configuration view illustrating another exemplary power transmission structure of a hybrid vehicle according to the present invention;

FIG. 9 is a schematic configuration view illustrating still another exemplary power transmission structure of a hybrid vehicle according to the present invention;

FIG. 10 is a schematic configuration view illustrating a related-art power transmission structure of a Sonata hybrid vehicle from Hyundai;

FIG. 11 is a schematic configuration view illustrating a related-art power transmission structure of a hybrid vehicle from Nissan;

FIG. 12 is a schematic configuration view illustrating a related-art power transmission structure of a hybrid vehicle from Toyota;

FIG. 13 is a schematic configuration view illustrating a related-art power transmission structure of a hybrid vehicle from Chevrolet; and

FIGS. 14 and 15 are schematic configuration views illustrating a related-art power transmission structure of a hybrid vehicle in which a double clutch or a dual clutch is provided.

### DETAILED DESCRIPTION OF THE INVENTION

Reference will now be made in greater detail to exemplary embodiments of the present invention, examples of which are illustrated in the accompanying drawings. Wherever possible, the same reference numerals will be used throughout the drawings and the description to refer to the same or like parts. In the following description of the embodiments of the present invention, descriptions of components not directly related to the principle of the present invention or components obvious to a person skilled in the art will be omitted.

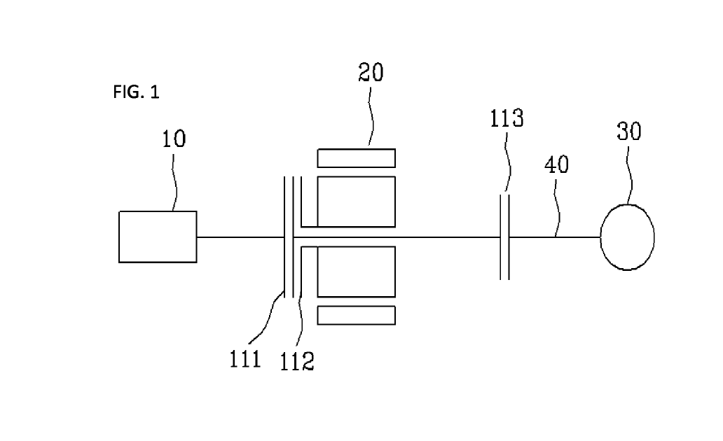

FIGS. 1 to 8 are schematic configuration views illustrating exemplary power transmission structures of hybrid vehicles according to the present invention. As illustrated in FIGS. 1 to 8, according to the technical features of the present invention, an engine 10, a motor 20, a transmission 30, and first to third clutches 111, 112, and 113 or a triple clutch 211, 212, and 213 are provided. Detailed descriptions of these configurations will be now given.

The engine 10 may be an internal combustion engine typically used in the art to which the present invention relates. Although not illustrated, the present invention does not exclude a case in which a low-voltage starter, more particularly, a 12 V starter, is provided on one side of the engine 10. The 12 V starter does not need a high-voltage electrical connector unit or a control unit unlike the starter generator.

The motor 20 is a motor/generator typically used in the art to which the present invention relates. The motor/generator is a means for generating mechanical power by consuming electricity or generating electricity using mechanical power applied thereto. The motor 20 is disposed at a predetermined distance from and parallel to the engine 10, and the rotary shaft of the motor 20 has a hollow structure, such that an output shaft 40 connected to the engine 10 extends through the hollow space of the motor 20. This configuration is intended to prevent part of power generated by the engine to be transmitted to the output shaft 40 from being reduced by the motor 20. Due to this configuration, the motor according to the present invention can have a large capacity considering the displacement of the engine.

The motor 20 is connected to a battery (not shown), and generates driving force consuming electricity charged in the battery. The motor can be one selected from among various types of motors that can be used as a driving source of a hybrid vehicle. In a regenerative braking mode, the motor can act as a generator.

The transmission 30 is a part that properly controls power generated by the engine 10 and/or the motor 20 and transfers power via the output shaft 40 to wheels (not shown). The transmission may be one selected from among a continuously variable transmission (CVT), a toroidal CVT, an automatic transmission (AT), and a dual-clutch transmission (DCT). A configuration connecting the transmission and the output shaft may vary depending on the type of the transmission. This means that a single clutch on the side of the transmission illustrated in the drawings is essential since the CVT does not have a neutral position. In addition, the single clutch on the side of the transmission can be omitted from the AT and the DCT since each of the AT and the DCT has a neutral position within the transmission.

Although the clutch employed in the present invention is basically a wet clutch, other types of clutches that are generally used in the industry may also be used. That is, the clutch disposed on one side of the engine may be implemented as a dry clutch, and the clutch disposed on one side of the motor and the clutch disposed on one side of the transmission may be implemented as magnetic clutches.

In particular, the clutch disposed on one side of the motor generator must remain in a disengaging position while the vehicle is being propelled by the engine alone but must be in an engaging position in the case of regenerative power generation or power generation by the engine. At this time, the numbers of revolutions must be synchronized in order to reduce contact shocks. The electronic magnetic clutch is advantageous in terms of synchronization. However, the wet clutch is also applicable since synchronization can be easily obtained when the number of revolutions of the motor is controlled before engagement.

As above, since the power transmission structure according to the present invention uses a single motor as a driving source to propel the vehicle in concert with the combustion engine, only a single electrical connector unit and a single control unit controlling the electrical connector unit may be sufficient. That is, the power transmission structure according to the present invention can be easily fabricated, thus significantly reducing fabrication cost. Further, the power transmission structure according to the present invention can make power transmission control easy since there are no electrical interferences, and it makes relevant repair and maintenance easy.

Detailed configurations of the first and second clutches 111 and 112 and the third clutch 113 or the triple clutch 211, 212, and 213 according to the present invention may be embodied as in FIGS. 1 to 8. Power transferring processes due to the operations thereof will be now described in detail.

First, referring to FIG. 1, the first and second clutches 111 and 112 are disposed on the output shaft 40 between the engine 10 and the motor 20, and the third clutch 113 is disposed on the output shaft 40 between the motor 20 and the transmission 30. The first and second clutches 111 and 112 are configured as a double clutch, which is disposed on one portion of the motor 20 facing the engine 10.

In this case, in a position in which the third clutch 113 is connected to the dual clutch, when the first clutch 111 operates to connect the output end of the engine 10 to the output shaft 40, power generated by the engine 10 is transferred to the transmission 30. When the second clutch 112 operates to connect the output end (i.e. the rotary shaft) of the motor 20, power generated by the motor 20 is transferred to the transmission 30 or is used for regenerative power generation.

In addition, when both the first and second clutches 111 and 112 operate to connect the output end of the engine 10 and the output end of the motor 20 to the output shaft 40, power generated by the engine 10 and power generated by the motor 20 is transferred to the transmission 30. On the other hand, in a position in which the third clutch 113 is disengaged, when the first and second clutches 111 and 112 operate to connect the output end of the engine 10 to the output end of the motor 20, power generated by the engine 10 is entirely transferred to the motor 20. In this case, it is possible to start the engine 10 by driving the motor 20.

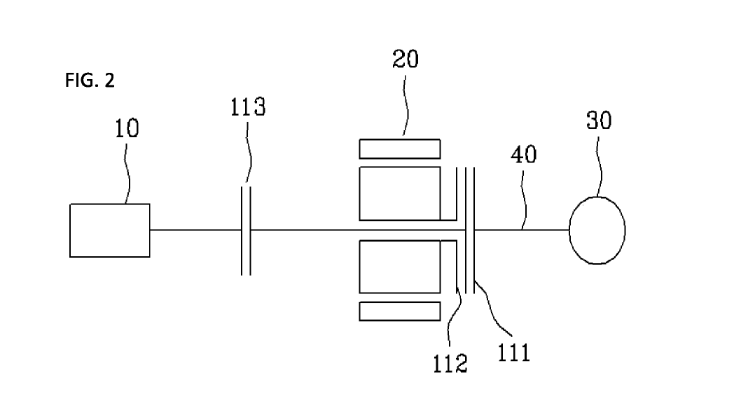

Referring to FIG. 2, the second and first clutches 112 and 111 are disposed on the output shaft 40 between the motor 20 and the transmission 30, and the third clutch 113 is disposed on the output shaft 40 between the engine 10 and the motor 20. Here, the second clutch 112 and the first clutch 111 are configured as a double clutch, and are disposed on the other portion of the motor 20 facing the transmission 30. In FIG. 2, the power transmission process due to the operations of the first to third clutches 111 to 113 is substantially the same as that of FIG. 1 above.

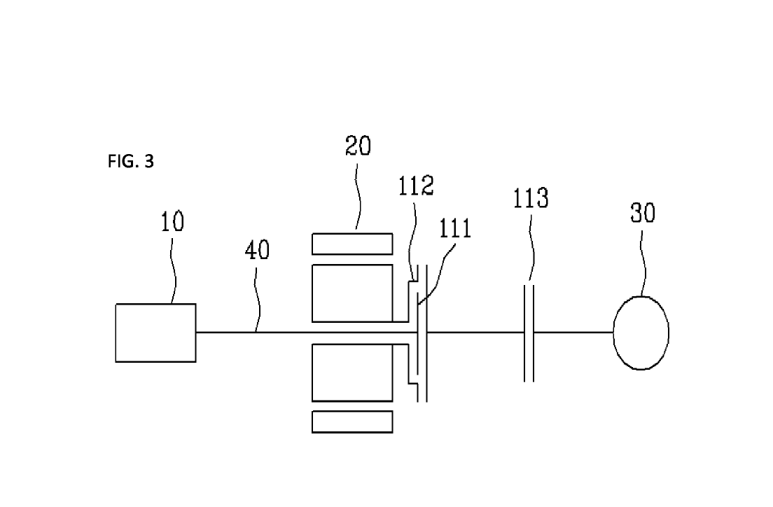

Referring to FIG. 3, all of the second clutch 112, the first clutch 111, and the third clutch 113 are disposed on the output shaft 40 between the motor 20 and the transmission 30. More specifically, it is preferable that the second and first clutches 112 and 111 be disposed on the other portion of the motor 20 facing the transmission 30, and that the third clutch 113 be disposed between the second and first clutch 112 and 111 and the transmission 30. Here, the second and first clutches 112 and 111 are configured as a dual clutch. In each case of FIGS. 1 and 2 above, the both sides of the first and second clutches 111 and 112 act as means for enabling/disabling contact. On the other hand, in FIG. 3, one side of each of the second and first clutches 112 and 111 acts as a means for enabling/disabling contact. Detailed descriptions of related technologies will be omitted since they are well known in the art. In FIG. 3, the power transmission process due to the operations of the second, first, and third clutches 112, 111, and 113 is substantially the same as that of FIG. 1 above.

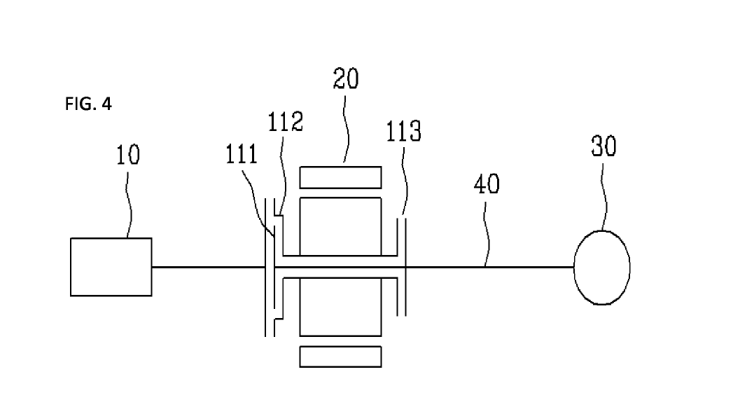

Referring to FIG. 4, the first and second clutches 111 and 112 are disposed on the output shaft 40 between the engine 10 and the motor 20, and the third clutch 113 is disposed on the output shaft 40 between the motor 20 and the transmission 30. This configuration is similar to the configuration of FIG. 1 above, except that the third clutch 113 enables/disables power generated by the motor 20 to be transferred to the output shaft 40. Here, the first and second clutches 111 and 112 are configured as a double clutch or a dual clutch.

In a position in which the third clutch 113 is disengaged, when the first clutch 111 operates to connect the output end of the engine 10 to the output shaft 40, power generated by the engine 10 is transferred to the transmission 30. And in a position in which the third clutch 113 is disengaged, when the first and second clutches 111 and 112 are connected, power generated by the engine 10 and the motor 20 is transferred to the transmission 30. In addition, in a position in which the third clutch 113 is disengaged, when the second clutch 112 is engaged only, the output end of the engine 10 is connected to the input end of the motor 20 (i.e. the left portion of the motor 20 in FIG. 4). In this position, it is possible to generate electricity by rotating the motor 20 using the engine 10 or start the engine 10 using the motor 20.

On the other hand, in a position in which neither the first clutch 111 nor the second clutch 112 operates, when the third clutch 113 operates to connect the output end of the motor 20 (the right portion of the motor 20 in FIG. 4) to the output shaft 40, power generated by the motor 20 is transferred to the transmission 30, whereby the vehicle can be propelled or regenerative power generation can be performed during deceleration. In addition, when the second clutch 112 is disengaged and the first clutch 111 and the third clutch 113 operate to connect the output end of the engine 10 and the output end of the motor 20 to the output shaft 40, power generated by the engine 10 and power generated by the motor 20 is transferred to the transmission 30.

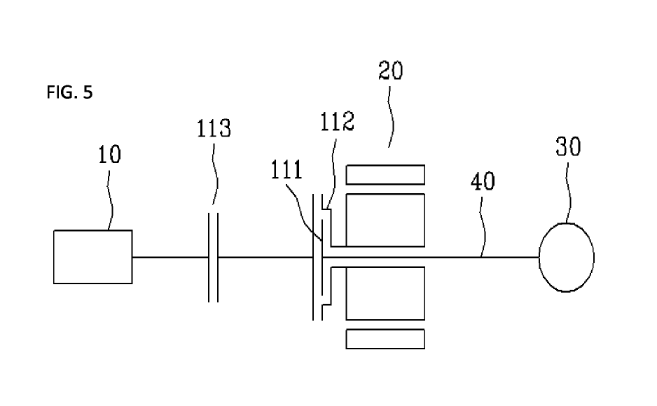

Referring to FIG. 5, the third, first, and second clutches 113, 111, and 112 are disposed between the engine 10 and the motor 20. The configuration in FIG. 5 is similar to that of FIG. 3 above, except that the third clutch 113 is disposed between the engine 10 and the motor 20, and the first and second clutches 111 and 112 are disposed between the third clutch 113 and the motor 20.

Here, the first and second clutches 111 and 112 are disposed on one portion of the motor 20 facing the third clutch 113, and are configured as a dual clutch.

In this case, in a position in which the third clutch 113 is engaged, when the first clutch 111 operates to connect the output end of the engine 10 to the output shaft 40, power generated by the engine 10 is transferred to the transmission 30. And in a position in which the third clutch 113 is engaged, when both the first clutch 111 and the second clutch 112 operate to connect the output end of the engine 10 and the output end of the motor 20 to the output shaft 40, and power generated by the engine 10 and power generated by the motor 20 is transferred to the transmission 30. On the other hand, in a position in which the third clutch 113 is engaged, when the second clutch 112 operates to connect the output end of the engine 10 to the output end of the motor 20 and the first clutch 111 is disengaged, power generated by the engine is entirely transferred to the motor 20, whereby power generation can be performed or the engine 10 can be started by driving the motor 20. In a position in which the third clutch 113 is disengaged, when the first and second clutches 111 and 112 operate to connect the output end of the motor 20 to the output shaft 40, power generated by the motor 20 is transferred to the transmission 30 or is used for regenerative power generation.

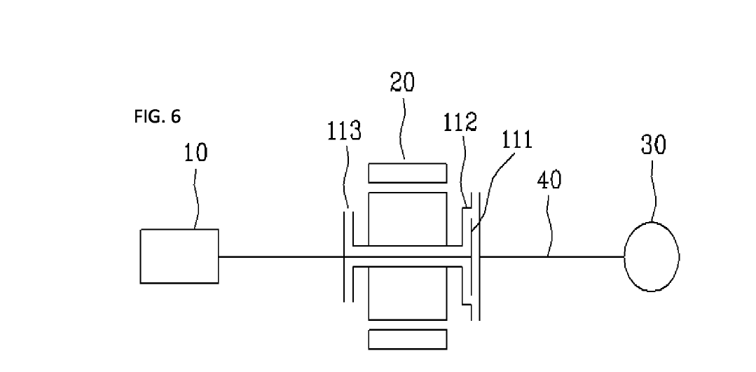

Referring to FIG. 6, the third clutch 113 is disposed on the output shaft 40 between the engine 10 and the motor 20, and the second and first clutches 112 and 111 are disposed on the output shaft 40 between the motor 20 and the transmission 30. Here, the second and first clutches 112 and 111 may be configured as a double clutch or a dual clutch. The positions of the first, second, and third clutches 111, 112, and 113 in FIG. 6 are different from those of FIG. 4.

In FIG. 6, the third clutch 113 enables/disables the contact between the input end of the motor 20 (the left portion of the motor 20 in FIG. 6) and the output end of the engine 10. That is, when the third clutch 113 operates in a position in which the output end of the engine 10 and the output end of the motor 20 are disconnected from the output shaft 40, power generated by the engine 10 is transferred to the motor 20 via the input end of the motor 20, or the engine 10 can be started by driving the motor 20. The operations of the second and first clutches 112 and 111 as the dual clutch are substantially the same as those in FIG. 4 above.

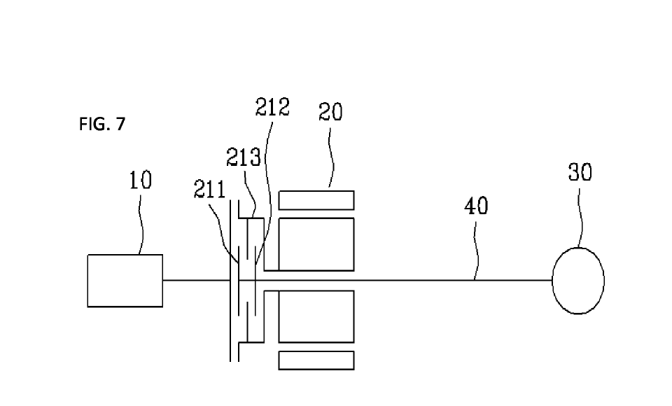

Referring to FIG. 7, the first clutch 211, the second clutch 212, and the third clutch 213 functioning as a triple clutch are disposed between the engine 10 and the motor 20. Here, it is preferable that the triple clutch be disposed on one portion of the motor 20 facing the engine 10. Unlike the configurations of FIGS. 1 to 6 above, the configuration of FIG. 7 is characterized by controlling power transfer using a single clutch structure.

When the first clutch 211 operates to connect the output end of the engine 10 to the output shaft 40, power generated by the engine 10 is transferred to the transmission 30 via the output shaft 40. On the other hand, when the second clutch 212 operates to connect the output end of the motor 20 to the output shaft 40, power generated by the motor 20 is transferred to the transmission 30 or is used for regenerative power generation.

In addition, when the first and second clutches 211 and 212 operate to connect the output end of the engine 10 and the output end of the motor 20 to the output shaft 40, power generated by the engine 10 and power generated by the motor 20 is transferred to the transmission 30. When the third clutch operates 213 to connect the output end of the engine 10 to the output end of the motor 20, power generated by the engine 10 is entirely transferred to the motor 20. In addition, the engine 10 can be started by driving the motor 20.

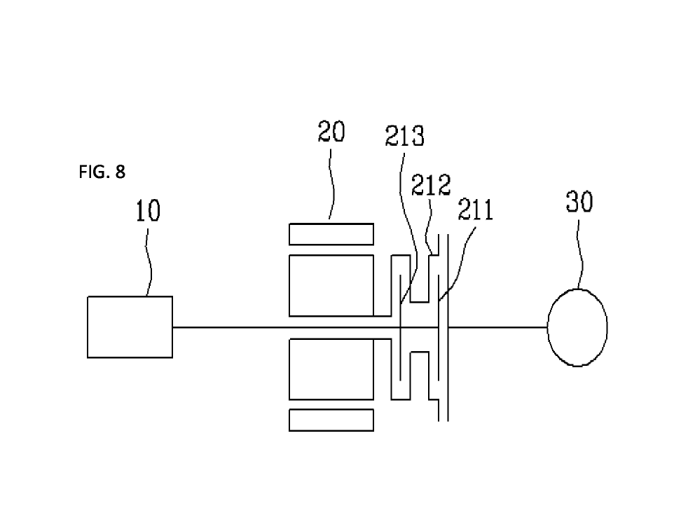

Referring to FIG. 8, the third, second, and first clutches 213, 222, and 211 functioning as a triple clutch are disposed between the motor 20 and the transmission 30. It is preferable that the triple clutch be disposed on the other portion of the motor 20 facing the transmission 30. In this case, when the first clutch 211 operates to connect the output end of the engine 10 to the output shaft 40, power generated by the engine 10 is transferred to the transmission 30 via the output shaft 40. When the second clutch 212 operates to connect the output shaft of the motor 20 to the output shaft 40, power generated by the motor 20 is transferred to the transmission 30 or is used for regenerative power generation.

When the first and second clutches 211 and 212 operate to connect the output end of the engine 10 and the output end of the motor 20 to the output shaft 40, power generated by the engine 10 and power generated by the motor 20 is transferred to the transmission 30. When the third clutch 213 operates to connect the output end of the engine 10 to the output end of the motor 20, power generated by the engine 10 can be entirely transferred to the motor 20 or the engine 10 can be started by driving the motor 20.

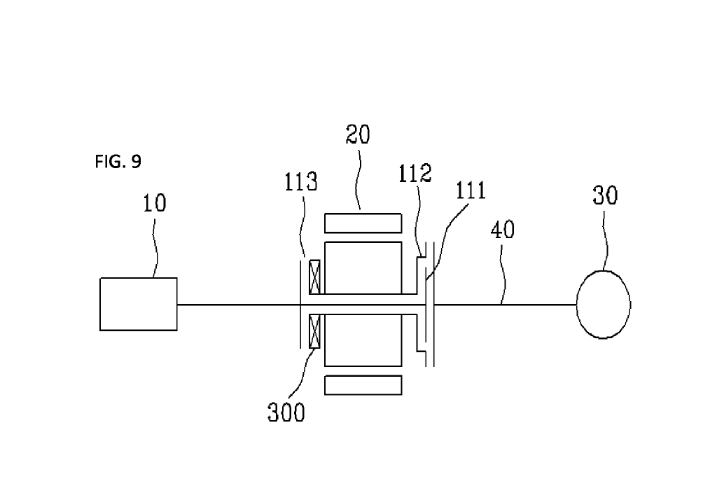

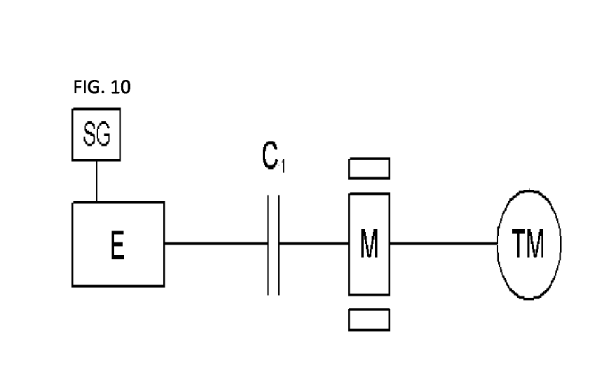

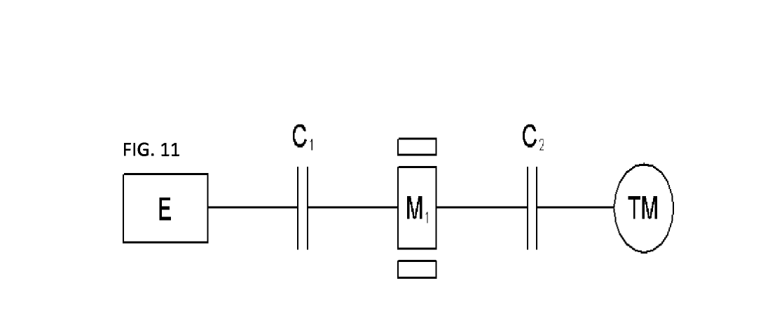

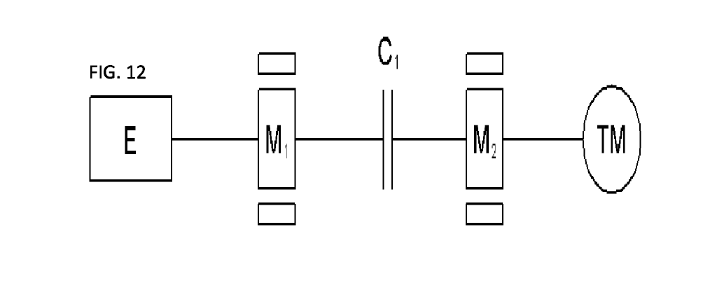

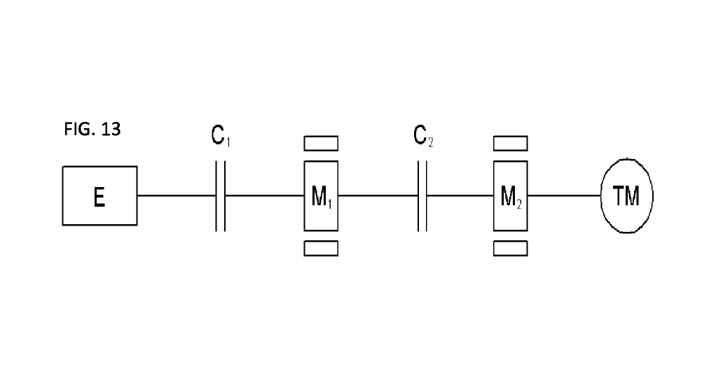

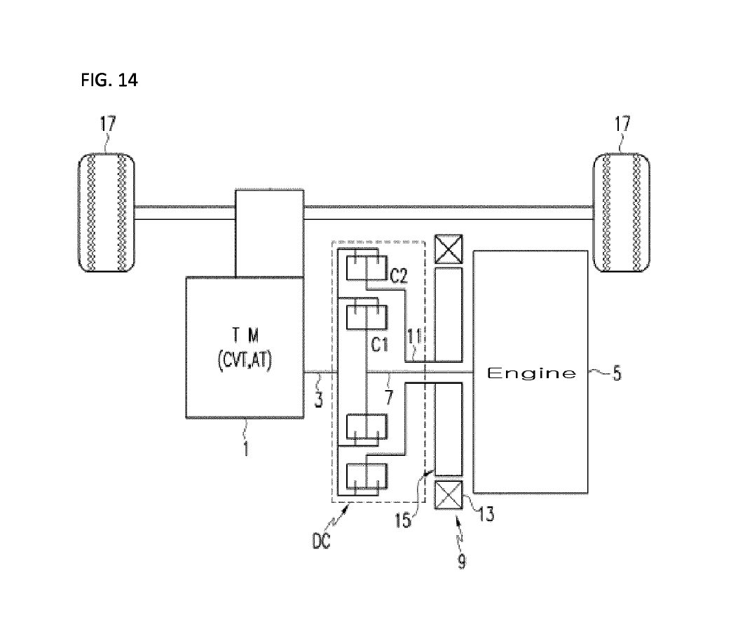

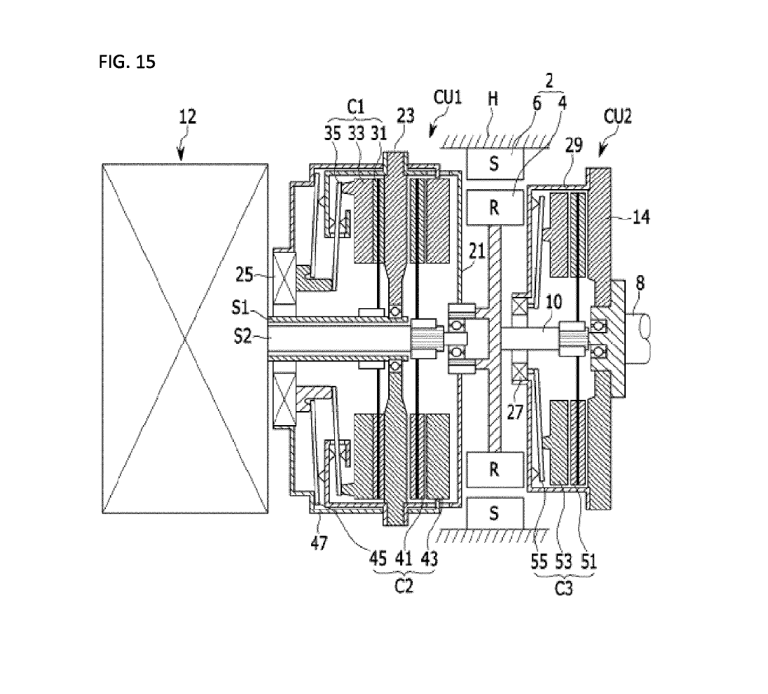

FIG. 9 illustrates an exemplary configuration in which a planetary gear set 300 is disposed on the input end of the motor 20. Like this, the present invention does not exclude the case in which the planetary gear set is disposed on the output end or the input end of the motor 20. It is preferable that the ratio of input revolutions to output revolutions in the planetary gear set be fixed. As is well known in the art, the planetary gear set includes a sun gear, planetary gears, and a ring gear. When power is input in a position in which the gear ratio of one of the gears is fixed, an output is generated according to the gear ratio of the other two gears. For example, when power is input to the planetary gear set in a position in which the gear ratio of the sun gear is fixed, an output is generated according to the gear ratio of the planetary gear and the ring gear.

The present invention proposes the configuration including the planetary gear set on the output end (or the input end) of the motor 20 because the number of revolutions of the engine 20 having the highest efficiency (the size of horsepower and the level of torque generated with respect to the amount of fuel consumed) differs from the number of revolutions of the motor 20 having the highest efficiency (the amount of power generated with respect to the number of revolutions). For example, when the engine has the highest output efficiency at 2,000 rpm and the motor has the highest electric power generation efficiency at 3,000 rpm, highest energy efficiency can be obtained by disposing the planetary gear set, with the ratio of input revolutions to output revolutions being fixed to 1:1.5, between the engine and the motor instead of directly connecting the engine and the motor.

Thus, the present invention has the planetary gear set disposed on the output end (or the input end) of the motor 20, in which the ratio of the number of input revolutions to the number of output revolutions of the planetary gear set is fixed to a predetermined value, whereby the motor 20 can generate electricity with highest performance using input power. It is therefore possible to advantageously improve fuel efficiency and the efficiency of regenerative power generation. In addition, power generated by the motor 20 can have a high level of torque, which can have advantageous effects on the driving of the vehicle in several aspects. Although no hybrid vehicles of the related art were equipped with an electric generator having efficient power generation ability in comparison to the performance of the engine, which is problematic, the present invention can easily overcome this problem.

When the power of a vehicle is controlled using the first to third clutches or the triple clutch as in the present invention, the driving modes of the vehicle can be divided into an engine mode, a electric vehicle mode, a parallel mode, a combined mode, a regenerative braking mode, an engine generation mode, and a start mode. These driving modes will now be described in brief.

Engine Mode

In the configurations of FIGS. 1, 2, 3, and 5, the engine mode is a vehicle-driving mode in which the first clutch 111 operates to connect the output end of the engine 10 to the output shaft 40 in a position in which the third clutch 113 is engaged. In this mode, the second clutch 112 is disengaged. The operation of the motor 20 remains stopped, and the vehicle is propelled only by power generated by the engine 10.

In the configurations of FIGS. 4 and 6, the engine mode is performed such that the first clutch 111 operates to connect the output end of the engine 10 to the output shaft 40. Here, neither the second clutch 112 nor the third clutch 113 operates, but both the second and third clutches 112 and 113 remain disengaged. In the configurations of FIGS. 7 and 8, the first clutch 211 of the triple clutch operates to connect only the output end of the engine 10 to the output shaft 40.

The engine mode is used when the vehicle is cruising with high rpm on a highway at a constant speed or the power of the battery is almost depleted. The present invention is free from power reduction by the motor mounted thereon even if the motor has a large capacity. Parasitic energy consumption of driven motor is absent. Consequently, power generated by the engine to be transferred to the output shaft is entirely transferred to the transmission without loss.

Electric Vehicle Mode

In the configurations of FIGS. 1 and 3, the electric vehicle mode is a vehicle-driving mode in which the second clutch 112 operates to connect the output end of the motor 20 to the output shaft 40 in a position in which the third clutch 113 is engaged. In this mode, the first clutch 111 is disengaged. The operation of the engine 10 remains stopped, and the vehicle is propelled by power generated by the motor 20. The motor 20 generates power by consuming electricity charged in the battery or by consuming electricity created through regenerative power generation occurring according to the driving conditions of the vehicle.

In the configurations of FIGS. 2 and 5, the electric vehicle mode is performed such that the first clutch 111 and the second clutch operate to connect the output end of the motor 20 to the output shaft 40 in a position in which the third clutch 113 is disengaged.

In the configuration of FIG. 4, the electric vehicle mode is performed such that the third clutch 113 operates to connect the output end of the motor 20 to the output shaft 40. Here, both the first clutch 111 and the second clutch 112 are disengaged. In the configuration of FIG. 6, the electric vehicle mode is performed such that the second clutch 112 operates to connect the output end of the motor 20 to the output shaft 40. The first and third clutches 111, 113 are disengaged. Here, the engine 10 is disconnected from the output shaft 40. In the configurations of FIGS. 7 and 8, the electric vehicle mode is performed such that the second clutch 212 of the triple clutch operates to connect the output end of the motor 20 to the output shaft 40. Here, the first and third clutches 211 and 213 are disengaged.

The electric vehicle mode is most efficient in terms of energy consumption when the vehicle runs at or below a predetermined speed in a predetermined range using electricity charged in the battery. However, in the case of hybrid vehicles of the related art, the connection between the engine and the motor cannot be controlled or a motor having a large capacity in comparison to the displacement of the engine cannot be mounted due to power reduced by the motor. Parasitic energy consumption of driven motor having a large capacity is inevitable.

In contrast, the present invention allows for the motor having a large capacity to be mounted by proposing the configuration for preventing power from being reduced by the motor by controlling the connection between the engine and the motor by disposing the clutch between the engine and the motor. Thus, the present invention can maximize the driving range of a hybrid vehicle in which the motor can participate, thereby significantly improving the fuel efficiency of the hybrid vehicle through the entire driving range, unlike hybrid vehicles of the related art.

Parallel Mode

In the configurations of FIGS. 1, 2, 3, and 5, the parallel mode is a vehicle-driving mode in which the first clutch 111 and the second clutch 112 operate to connect the output end of the engine 10 and the output end of the motor 20 to the output shaft 40 in a position in which the third clutch 113 is engaged. Thus, power generated by the engine 10 and power generated by the motor 20 is transferred to the transmission 30 via the output shaft 40.

In the configurations of FIGS. 4 and 6, the parallel mode is performed such that the first clutch 111 and the second clutch 112 operate to connect the output end of the engine 10 and the output end of the motor 20 to the output shaft 40. On the other hand, the parallel mode can be performed when the first clutch 111 is connected to the third clutch 113. In this position, one of the second and third clutches 112 and 113 is engaged, and the other one of the second and third clutches 112 and 113 is disengaged.

In the configurations of FIGS. 7 and 8, the parallel mode is performed such that the first clutch 211 and the second clutch 212 of the triple clutch operate to connect the output end of the engine 10 and the output end of the motor 20 to the output shaft 40. On the other hand, the parallel mode can be performed when the third clutch 213 is engaged in a position in which the first clutch 211 is engaged. In this position, one of the second and third clutches 212 and 213 is engaged and the other one of the second and third clutches 212 and 213 is disengaged.

Similarly, over all types of hybrid vehicles, the parallel mode is applied to the case in which a vehicle rapidly accelerates or runs at or above a predetermined speed. In contrast, the present invention provides a structure on which the motor having a large capacity in comparison to the displacement of the engine can be mounted, such that the motor can participate in the driving of the vehicle by generating a considerable amount of power, unlike in the parallel mode of hybrid vehicles of the related art.

When the planetary gear set is disposed on the input end of the motor 20 as in FIG. 9, the motor 20 generates power according to the fixed ratio of revolutions (i.e. ratio of input revolutions to output revolutions) of the planetary gear set. Power generated by the motor 20 participates in the driving of the vehicle with a high level of toque due to the ratio of revolutions of the planetary gear set.

Combined Mode

The combined mode is a mode allowing the battery to be charged during the driving of the vehicle. The engagement/disengagement of each clutch in the combined mode is the same as in the above-described parallel mode. Hybrid vehicles of the related art must be equipped with a motor having a relatively small capacity, since the fuel efficiency thereof significantly decreases when the motor mounted thereon has a large capacity in comparison to the displacement of the engine. When the motor having a small capacity is mounted in order to prevent the fuel efficiency of the engine from decreasing, the ability of the motor to generate electricity is lowered, thereby decreasing the fuel efficiency of the engine.

In contrast, the present invention provides the power transmission structure on which the motor having a large capacity can be mounted, whereby the power transmission structure can operate in a condition in which power is left during the driving. Therefore, both driving and power generation can be performed without hindering the driving ability of the vehicle, thereby significantly improving the problems of hybrid vehicles of the related art. When the planetary gear set is added to the motor as in FIG. 9, the efficiency of electric power generation of the motor 20 can be significantly improved, thereby improving the fuel efficiency of the engine 10.

Regenerative Braking Mode

The regenerative braking mode is a mode of charging the battery by rotating the motor 20 using power transferred sequentially via wheels and the transmission 30. In the regenerative braking mode, the engagement/disengagement of each clutch is the same as in the above-described electric vehicle mode. The operation of the engine 10 remains stopped.

In the regenerative braking mode, when the planetary gear set is disposed on the input end of the motor 20 and the input end of the motor 20 on which the planetary gear set is disposed is connected to the output shaft 40, power transferred to the output shaft 40 via the wheels and the transmission 30 rotates the motor 20 at a ratio of revolutions set to the planetary gear set. Thus, the motor 20 can generate electricity with optimum efficiency.

Engine Generation Mode

The engine generation mode is a mode of generating electricity by rotating the motor 20 using power generated by the engine 10. Referring to FIGS. 1 and 3, the engine generation mode is performed such that the first clutch 111 and the second clutch 112 operate to connect the output end of the engine 10 and the output end of the motor 20 in a position in which the third clutch 113 is disengaged. Referring to FIGS. 2 and 5, the engine generation mode is performed such that the second clutch 112 operates to connect the output end of the motor 20 to the output end of the engine 10 in a position in which the third clutch 113 is engaged. Here, the first clutch 111 is in a disengaged position.

Referring to FIG. 4, the second clutch 112 operates to connect the input end of the motor 20 to the output end of the engine 10, and the first clutch 111 and the third clutch 113 are in a disengaged position. Referring to FIG. 6, the third clutch 113 operates to connect the output end of the motor 20 to the output end of the engine 10, and the first clutch 111 and the second clutch 112 are in a disengaged position.

In addition, referring to FIGS. 7 and 8, the engine generation mode is performed such that the third clutch 213 operates to connect the output end of the motor 20 to the output end of the engine 10. The first clutch 211 and the second clutch 212 are in a disengaged position.

The generation mode according to the present invention may be embodied in two types during the driving of the vehicle. One type of the generation mode is enabled when a running vehicle stops, and the other type of the generation mode is enabled when the vehicle is propelled with inertia down a hill. The former type of the generation mode may be performed similarly to the idle stop and go (ISG) function of the related art. The present invention can significantly increase the amount of power generation since the motor having a large capacity in comparison to the displacement of the engine is mounted. When the planetary gear set is added, power generation can be performed with highest efficiency at an optimum number of revolutions.

Start Mode

The start mode is a mode of starting the engine 10 using the motor 20. In the start mode, the engagement/disengagement of each clutch is the same as in the above-described engine generation mode.

The start mode according to the present invention can be enabled purely by the motor. That is, the motor according to the present invention can function as not only the drive motor and the generator, but also the starter. Thus, an alternator, a low-voltage generator, is not required, and a belt connected to the engine to rotate the generator and the compressor is not required. Thus, the power transmission structure according to the present invention is much simpler than those of hybrid vehicles of the related art.

However, the present invention does not exclude the case in which a low-voltage starter, for example, a 12V starter, is added on one portion of the engine in order to facilitate starting. In this case, it is apparent that starting must be performed in a position in which the output end of the engine is disconnected from the output shaft.

Although the exemplary embodiments of the present invention have been described for illustrative purposes, a person skilled in the art will appreciate that various modifications, additions and substitutions are possible, without departing from the scope and spirit of the present invention as disclosed in the accompanying claims.

What is claimed is:

1. A power transmission structure of a hybrid vehicle, comprising:
a motor generator;
a first clutch, a second clutch, and a third clutch;
an engine;
a motor; and
an output shaft transferring power generated by the engine and power generated by the motor to a transmission,
wherein the motor is disposed parallel to the engine, the output shaft extends through a central portion of the motor and is connected to the transmission, the first clutch and the second clutch are disposed as a double clutch on the output shaft between the engine and the motor, and the third clutch is disposed between the motor and the transmission to enable and disable power to be transferred via the output shaft.

2. A power transmission structure of a hybrid vehicle, comprising:
a motor generator;
a first clutch, a second clutch, and a third clutch;
an engine;
a motor; and
an output shaft transferring power generated by the engine and power generated by the motor to a transmission,
wherein the motor is disposed parallel to the engine, the output shaft extends through a central portion of the motor and is connected to the transmission, the second clutch and the first clutch are disposed as a double clutch on the output shaft between the motor and the transmission, and the third clutch is disposed between the motor and the engine to enable and disable power to be transferred via the output shaft.

3. A power transmission structure of a hybrid vehicle, comprising:
a motor generator;
a first clutch, a second clutch, and a third clutch;
an engine;
a motor; and
an output shaft transferring power generated by the engine and power generated by the motor to a transmission,
wherein the motor is disposed parallel to the engine, the output shaft extends through a central portion of the motor and is connected to the transmission, the second clutch and the first clutch are disposed as a double clutch on the output shaft between the motor and the transmission, and the third clutch is disposed between the dual clutch and the transmission to enable and disable power to be transferred via the output shaft.

4. A power transmission structure of a hybrid vehicle, comprising:
a motor generator;
a first clutch, a second clutch, and a third clutch;
an engine;
a motor; and
an output shaft transferring power generated by the engine and power generated by the motor to a transmission,
wherein the motor is disposed parallel to the engine, the output shaft extends through a central portion of the motor and is connected to the transmission, the first clutch and the second clutch are disposed as a dual clutch or a double clutch on the output shaft between the engine and the motor, and the third clutch is disposed between the motor and the transmission to enable and disable power generated by the motor to be transferred via the output shaft.

5. A power transmission structure of a hybrid vehicle, comprising:
a motor generator;
a first clutch, a second clutch, and a third clutch;
an engine;
a motor; and
an output shaft transferring power generated by the engine and power generated by the motor to a transmission,
wherein the motor is disposed parallel to the engine, the output shaft extends through a central portion of the motor and is connected to the transmission, the first clutch and the second clutch are disposed as a dual clutch on the output shaft between the engine and the motor, and the third clutch is disposed between the engine and the dual clutch.

6. A power transmission structure of a hybrid vehicle, comprising:
a motor generator;
a first clutch, a second clutch, and a third clutch;
an engine;
a motor; and
an output shaft transferring power generated by the engine and power generated by the motor to a transmission,
wherein the motor is disposed parallel to the engine, the output shaft extends through a central portion of the motor and is connected to the transmission, the third clutch is disposed between the engine and the motor, and the second clutch and the first clutch are disposed as a dual clutch or a double clutch on the output shaft between the motor and the transmission.

7. A power transmission structure of a hybrid vehicle, comprising:
a motor generator;
a first clutch, a second clutch, and a third clutch;
an engine;
a motor; and
an output shaft transferring power generated by the engine and power generated by the motor to a transmission,
wherein the motor is disposed parallel to the engine, the output shaft extends through a central portion of the motor and is connected to the transmission, the first clutch, the second clutch, and the third clutch are disposed as a triple clutch on the output shaft between the engine and the motor.

8. A power transmission structure of a hybrid vehicle, comprising:
a motor generator;
a first clutch, a second clutch, and a third clutch;
an engine;
a motor; and
an output shaft transferring power generated by the engine and power generated by the motor to a transmission,
wherein the motor is disposed parallel to the engine, the output shaft extends through a central portion of the motor and is connected to the transmission, and the third clutch, the second clutch, and the first clutch are disposed as a triple clutch on the output shaft between the motor and the transmission.
